(19) United States
(12) Patent Application Publication
(10) Pub. No.: US 2021/0316234 A1
(43) Pub. Date: Oct. 14, 2021

(54) FILTER PRESS

(71) Applicant: Jürgen Berthold, Eckental (DE)

(72) Inventors: Jürgen BERTHOLD, Eckental (DE); Hermann BERTHOLD, lgensdorf (DE)

(21) Appl. No.: 17/225,264

(22) Filed: Apr. 8, 2021

(30) Foreign Application Priority Data
Apr. 14, 2020 (DE) 10 2020 110 177.5

(51) Int. Cl. B01D 25/172; B01D 25/21; B01D 25/19; B01D 37/04

(52) U.S. Cl. CPC B01D 25/172; B01D 37/045; B01D 25/19; B01D 25/215

(57) ABSTRACT

A filter press, including a housing, which receives a liquid to be filtered that contains particles to be separated off, and a pressing device arranged in the housing for pressing the liquid through a filter device, wherein the pressing device, which rotates about a vertical axis, has at least one cross-sectionally round pressing element which rotates about an axis of rotation situated at an angle to the vertical axis and which has an outer casing formed from an elastic material, by which the pressing element rolls on the filter device, wherein the filter device includes a filter and, upstream of the filter, a filter plate which has a plurality of apertures which are open toward the pressing element and each of which has a cross section reducing toward the filter.

### CROSS-REFERENCE TO RELATED APPLICATIONS

The present application claims priority of DE 10 2020 110 177.5, filed Apr. 14, 2020, the priority of this application is hereby claimed and this application is incorporated herein by reference.

### BACKGROUND OF THE INVENTION

The invention relates to a filter press, comprising a housing, which receives a liquid to be filtered that contains particles to be separated off, and a pressing device arranged in the housing for pressing the liquid through a filter device.

Liquids laden with particles occur in different work or economic sectors. Such a liquid contains solids particles, be they relatively large particles or suspended materials, which have to be separated off in order for the filtered liquid either to be further processed for further, deeper cleaning or for the liquid to be used further. An example of such a liquid is for example laden water which, mixed with fermenter wastes, originates from a biogas plant, maize silage, and otherwise laden or contaminated water which is laden with organic wastes such as feces, straw, grass, etc. Such laden water is often also generally referred to as “slurry”. Since such a liquid or “slurry” is still laden with relatively coarse dirt particles, it can be filtered with a filter press in order to filter off a large fraction of the contained dirt particles. This filtering step can either be a first step within a further cleaning chain, or a single filtering step if, depending on the intended further use, the filtered water is cleaned to a correspondingly sufficient degree. Such a filter press comprises a housing into which the liquid to be filtered is introduced, customarily being pumped in via a pipeline. In the housing there is a provided a filter device which is assigned a pressing device. The particle-laden contaminated water is situated above the filter device. The pressing device presses the laden water through the filter device, wherein, depending on the given mesh size of the filter device, the dirt particles remain suspended in the filter device and hence are separated from the liquid passing through the filter device.

Such a filter press operates discontinuously. The filter device mostly used takes the form of multilayer-stacked filter cloths or membranes.

The throughput over time through a filter press is not particularly high, since the filters in question are discontinuously operating pressure filters into which a specific amount of laden water, that is to say the suspension, is introduced, whereafter this specific amount is filtered. It is only after removal of the separated-off particles or of the filter cake that the filter press can be charged again.

### SUMMARY OF THE INVENTION

The problem on which the invention is based is thus that of specifying a filter press that is improved in relation to what has been described above.

To solve this problem, there is provision according to the invention, in a filter press of the type stated at the outset, that the pressing device, which rotates about a vertical axis, has at least one cross-sectionally round pressing element which rotates about an axis of rotation situated at an angle to the vertical axis and which has an outer casing formed from an elastic material, by means of which the pressing element rolls on the filter device, wherein the filter device comprise a filter means and, upstream of the filter means, a filter plate having apertures which are open toward the pressing element and each of which has a cross section reducing toward the filter means.

The filter press according to the invention is distinguished by a pressing element which is rotatable about two axes. On the one hand, the pressing element is rotatable about a central, vertically rising axis of rotation. It extends away from the axis of rotation at an angle such that, during a rotation of the axis of rotation, said pressing element performs a 360° rotation. Moreover, the pressing device itself is rotatable about a second axis of rotation situated at an angle to the vertical axis. That is to say that, during a 360° rotation about the vertical axis, the pressing element also rotates multiple times about itself.

The pressing element itself is round, that is to say roller-shaped, and has an outer casing composed of an elastic material. It is by way of this outer casing that said pressing element rolls on the filter device during a 360° rotation, bearing with a corresponding pressure, that is to say under preloading, against the filter device by the elastic outer casing. The filter device itself has a filter means which, via the diameter of the filter openings or screen openings, defines what the maximum size of a particle can be in order to get through the filter means and what particles are retained. This filter means, for example a hole filter consisting of a thin perforated metal filter sheet or of a perforated, preferably tear-resistant, plastics film, is assigned, upstream thereof toward the pressing element, a filter plate which has a multiplicity of apertures open toward the pressing element. The apertures change their cross section, as viewed from the pressing element to the filter means, with the aperture cross section reducing in this direction, that is to say that the cross-sectional area decreases toward the filter means.

If the pressing device now rotates about the vertical axis, the thereby revolving pressing device rolls on the filter plate by way of the elastic outer casing and rotates about itself in the process. During this rotary movement, the elastic outer casing presses against the filter plate and is thereby deformed. However, at the same time, the outer casing also presses the particle-laden liquid into the apertures of the filter plate, which, as described, taper toward the filter means. As a result, and by virtue of the fact that what is concerned is an elastic outer casing, the pressure is increasingly raised within the aperture closing as it is being rolled over, resulting in the fact that the liquid and fine particles passing through the filter means are pressed by the filter means, while at the same time larger particles are retained in the aperture by the filter means. The pressure increase within the respective aperture, resulting from the fact that the elastic material presses into the aperture, with the liquid thus being pressed out of the aperture, means that the separated particles remain behind. There is accordingly formed a filter cake consisting of the compressed, separated particles.

If the pressing element now rolls further, the aperture opens again. The pressed-out particles or the filter cake adhere/adheres on the elastic outer casing and, upon the pressing element being rotated away out of the aperture, are/is carried along and moved out of the aperture, with this being assisted by the resulting, decrease in pressure on account of the material moving away or being drawn out of the aperture. The compressed filter cake is thus automatically drawn or sucked out of the aperture as the pressing element rolls away. Upon continued movement of the pressing element, the filter cake is detached from the elastic outer casing and floats in the particle-laden liquid, with the filter cake resultingly, on the basis of its weight, sinking and reaching a catching or collecting region, from where it can then be drawn off as a thick sludge. The pressed-through, filtered water likewise collects in a corresponding collecting region, from where it can be drawn off.

The filter press according to the invention allows a virtually continuous operation resulting from the rotary pressing method with simultaneous self-cleaning of the filter device. That is to say that it is possible for the housing to be resupplied quasi-continuously with laden liquid and for filtered liquid to be continuously drawn off and for the accumulating filter cakes or the thick sludge to be occasionally emptied.

The apertures are preferably round in cross section, this having proved to be advantageous in terms of the pressed filter cakes being pulled out or sucked out. What is to be understood here by round is not necessarily round in a circular sense; rather, a slightly elliptical cross-sectional shape is also conceivable.

As described, the aperture cross section decreases from the plate side facing toward the pressing element to the plate side facing toward the filter means, preferably reducing continuously. It is preferably the case here that the apertures have an opening angle of between 60°-120°, in particular between 75° and 105° and preferably of 90°. Here, the apertures should have a maximum diameter of 12 mm, in particular of 10 mm and preferably of 8 mm, and a minimum diameter of 8 mm, in particular of 6 mm and preferably of 5 mm. The particularly preferred configuration is one having a maximum diameter of 8 mm and a minimum diameter of 5 mm. That is to say that a maximum aperture cross section of about 50.2 mm² and a minimum aperture cross section of about 19.6 mm² are provided. However, the diameter can also be somewhat larger within the specified interval limits.

The filter device has, as described, a filter means and, arranged between the filter means and pressing element, a filter plate, with the filter means preferably being arranged directly on the underside of the filter plate, bearing against the latter. In order for this filter means also to be mounted or supported toward the other side, an advantageous development of the invention provides for the filter device to have, downstream of the filter means, a second filter plate having second apertures aligned with the apertures of the first filter plate. That is to say that, in the simplest case, there is as it were provided a three-layered structure of the filter device, namely the upper, first filter plate, the filter means, and the lower, second filter plate. The second filter plate also has apertures which are aligned with those of the first filter plate. Here, the diameter or the cross-sectional area of the apertures of the second filter plate does not have to correspond to the minimum diameter or the minimum cross section of the first filter plate, but it can also be somewhat larger. Preferably, however, the cross section of the second apertures, which are preferably configured as round bores, corresponds to the minimum cross section of the first apertures, thus preferably also having, for example, a diameter of 5 mm or a cross-sectional area of 19.6 mm².

The filter means itself is or comprises preferably a hole filter having a hole cross section of between 1-50 μm, in particular between 1-25 μm. Such a hole filter, which is preferably configured as a metal filter sheet, can be perforated over its surface with a multiplicity of corresponding holes, with it also being possible for these holes to be produced with a minimum diameter, accordingly making it possible for an extremely fine-mesh hole filter to be used. This hole filter or this metal filter sheet can form the filter means on its own, that is to say that only the hole filter or the metal filter sheet is arranged between the two filter plates. However, it is also conceivable for a filter nonwoven to be arranged directly downstream of the hole filter, that is to say for a filter nonwoven to be inserted between the hole filter and second filter plate. This filter nonwoven extends over the entire surface and forms a counterpressure layer, in order to keep the pressing pressure within the perforation high, and also a distribution layer between the hole filter and second filter plate, with the result that the pressed-through liquid can be distributed within this filter nonwoven and can flow to the corresponding apertures of the second filter plate and flow off from there. This is expedient as a multiplicity of apertures are arranged in a distributed manner over the surface of the filter device or of the two filter plates, accordingly making it possible for the liquid pressed through a plurality of apertures of the first filter plate to flow off not only via the directly assigned apertures of the second filter plate, but also through adjacent apertures.

The outer casing as elastic element is, as described above, ascribed a central function, since it rolls on the filter device under deforming preloading and is pressed into the rolled-over apertures and pulled out again. The outer casing is therefore expediently a covering composed of an elastomer, a thermoplastic elastomer or a rubber, that is to say that ultimately different, but sufficiently elastic, materials which can be correspondingly deformed can be used as outer casing.

In this regard, the outer casing can be a mat which is fastened to the pressing element. This mat is laid or clamped around an as it were roller-shaped carrier of the pressing element and for example welded at its end sides, resulting in a closed, encircling outer casing. This mat is, for example, adhesively bonded to the outer casing such that it is securely fixed there. As an alternative to using a mat, the elastic outer casing can also take the form of a coating, that is to say that the roller-shaped carrier is correspondingly coated with the elastic material, for example by spray application or dipping or the like.

In order to increase the throughput, it is expedient to provide not only one pressing element but rather a plurality of pressing elements which are arranged so as to be offset in the circumferential direction and which rotate jointly about the vertical axis. That is to say that use is made, for example, of two, three or four roller-shaped pressing elements which rotate jointly about the vertical axis, that is to say are arranged on a corresponding axis carrier. Two pressing elements are situated opposite one another so as to be offset by 180°, three pressing elements are arranged so as to be equidistantly offset from one another by 120°, whereas four pressing elements are arranged so as to be equidistant to one another by 90°. In each case, the corresponding through-pressing operation then occurs simultaneously at a plurality of positions, that is to say that, as compared with only one pressing element, the throughput can be doubled when using two pressing elements, can be tripled when using three pressing elements, and can be quadrupled when using four pressing elements.

The or each pressing element expediently has a frustoconical shape that allows constant rolling over the surface of the filter device. It is also expediently the case here that the filter device is frustoconical or funnel-shaped. That is to say that the filter device is a frustoconical or funnel-shaped ring whose opening angle to the vertical is 120°, for example. In such a case, it is then naturally also the case that the axis of rotation of the pressing element(s) is correspondingly set, as is also the opening angle for frustoconically configured pressing elements. For example, the frustoconical pressing element has an opening angle of 30°, with the result that the axis of rotation about which the pressing element rotates is at an angle of 45° to the vertical given an opening angle of the filter device of 60°.

The filter device itself expediently has a central opening through which the vertical axis runs. It is particularly preferable here for a collecting container for filter cakes consisting of compressed particles, or the thick sludge, to be arranged downstream of the opening of the filter device. As described, the compressed filter cakes are as it were pulled or sucked out of the apertures by the rolling elastic outer casing. They are detached from the outer casing with progressive rotation and are present as correspondingly large and relatively heavy bodies in the contaminated liquid. After they have been caused by the rotating outer lateral surface to be upwardly entrained as it were, they float in the liquid and thus float in the direction of the opening through which they pass into the collecting container situated thereunder that is filled with contaminated liquid. This effect can be assisted in particular by virtue of the fact that the filter device is preferably frustoconical or funnel-shaped, that is to say, as viewed from outside, is inclined toward the central opening, with the result that the filter cakes are also caused by the funnel shape of the filter device to float in the direction of the opening or slide into the latter on the filter device. The filter cakes can from time to time be removed or suction-extracted from the collecting container, which is in the housing, via a corresponding removal or inspection opening.

As described, the elastic outer casing was under pressure on the filter device. In order to be able to apply the desired, required pressure to the pressing element, the or each pressing element is expediently clamped against the filter device by way of a clamping device. This clamping device is, for example, a hydraulic or pneumatic cylinder, but it can also be a cylinder comprising a spring element, that is to say a cylinder having an integrated helical spring or compression spring or the like. The preloading is preferably settable, that is to say that, by corresponding setting on the, or of the, clamping element, the contact pressure can be varied or the setting can be configured in such a way that the contact pressure is equal over the entire length over which the outer casing bears against the filter device.

From a design point of view, the or each cylinder is preferably fastened by one end on a holder, on which the pressing element is rotatably mounted, and by the other end on a holder coupled to the axis. The respective mechanical connections are corresponding bearing eyes or articulation heads that allow a pivoting movement required for the purposes of assembly but also, where appropriate, when setting the contact pressure.

The vertical axis itself is expediently formed by means of a shaft which is mounted so as to be rotatable by way of bearing elements and which is coupled to a drive motor and to which the pressing element(s) is/are coupled. This shaft, which can be in one or more parts, that is to say can consist of linearly arranged, interconnected shaft portions, accordingly extends through the housing. It preferably has its upper end running out of the housing and is coupled outside the housing to the drive motor, with the result that the latter is accordingly not arranged in the damp housing interior. The shaft preferably has its lower end running into the collecting container, which, as described, is arranged adjoining the central opening of the filter device, with the shaft being rotatably mounted in the collecting container. Accordingly, the shaft preferably extends from the upper end, by which it is connected to the drive motor, into and through the housing down to the lower bearing end in the collecting container.

Accordingly, three separate housing regions can preferably be distinguished in the housing itself. Firstly, the upper housing region into which the contaminated liquid to be cleaned is introduced. Next to it, a first lower housing region, namely the collecting container for the cleaned liquid that is arranged downstream of the filter device, with the upper housing region being separated from the lower housing region, that is to say the collecting container, via the filter device. As third housing region there is provided a further lower housing region, namely the collecting container for the filter cakes, which is enclosed by the annular collecting container for the liquid. To draw off the cleaned liquid from the liquid collecting container there is provided a corresponding outlet connection to which a corresponding line can be connected, and, in just the same way, the filter cake collecting container can be subjected to suction extraction via a suction line which can be connected to an outlet connection.

As described, the filter press according to the invention allows a virtually continuous operation, that is to say that contaminated liquid can be continuously resupplied and cleaned liquid drawn off, and it is necessary from time to time for the filter cakes to be removed or suction-extracted from the collecting container. It is solely for this purpose that it may be required to briefly interrupt the operation, since the filter cake collecting container is connected to the upper housing region into which the contaminated water is fed, and accordingly contaminated water also arises in the collecting container, accordingly requiring brief emptying for filter cake removal, but with the operation being able to be continued again immediately afterwards. Preferably, however, the accumulating thick sludge formed from the filter cakes is extracted by suction such that no operational interruption is required and a completely continuous operation is possible. In order for the resupplying and drawing-off operation to be correspondingly controlled, it is expedient if a housing region has provided therein above the filter device a filling level-monitoring device which allows the filling level of the housing with contaminated liquid to be able to be continuously monitored. This filling level-monitoring device can be an electronic filling level-monitoring device which electronically detects the filling level, and, for example, the pump feeding the liquid is controlled in dependence on the detection result thereof. Alternatively, a purely visual filling level-monitoring device in the form of a riser can also be provided.

Alternatively or additionally, it is also conceivable for a filling level-monitoring device, for example also a riser, to be provided in the collecting container which receives the cleaned liquid and which is arranged downstream of the filter device. That is to say that the filling level of cleaned liquid is also monitored, this preferably being able to occur electronically such that in turn the pump drawing off the liquid can be controlled in a filling level-dependent manner. Alternatively, however, a purely visual filling level monitoring by way of a riser is also conceivable.

Finally, it is also conceivable for a filling level-monitoring device to be provided on or in the collecting container receiving the filter cakes. It is thus detected via this means how full this collecting container is in order that it can then be emptied from time to time.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows a perspective view of the filter press according to the invention,

FIG. 2 shows a longitudinal section view of the filter press from FIG. 1,

FIG. 3 shows an enlarged partial view with illustration of the pressing elements together with tensioning devices and filter device,

FIG. 4 shows an enlarged partial view for illustrating the angular relationships,

FIG. 5 shows a basic illustration to explain the operating principle of the filter press, and

FIG. 6 shows an exploded view of a filter device.

### DETAILED DESCRIPTION OF THE INVENTION

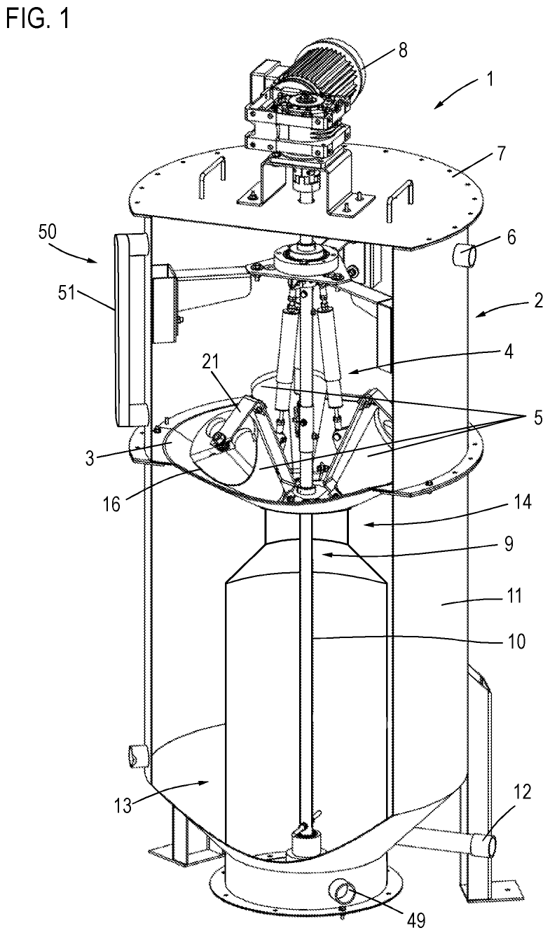

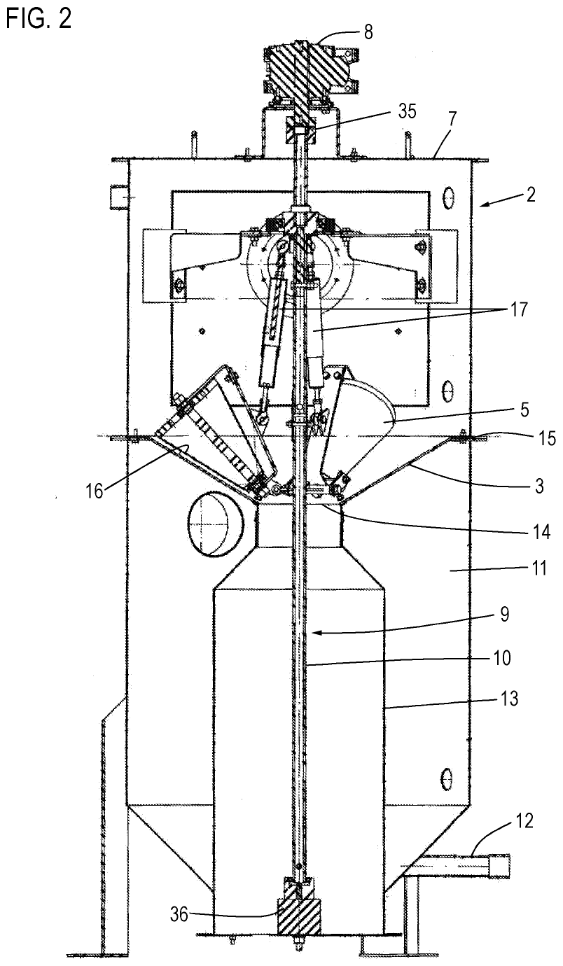

FIG. 1 shows a cut-open perspective view of a filter press 1 according to the invention, comprising a housing 2, in which there are arranged a filter device 3 and also a pressing device 4 comprising, in the example shown, three pressing elements 5. The upper region of the housing 2 is shown to be open here. In this region, liquid, preferably water, laden with particles to be filtered off, is fed in via an inflow 6. The housing 2 is closed to the top by way of a cover 7 on which there is seated a drive motor 8 which drives a shaft 10 which forms a vertical axis 9 and to which the pressing elements 5 are connected. The pressing elements 5 roll on the filter device 3 and press the water through the filter device 3, whereas a large fraction of the particles remain suspended in the filter device 3. The cleaned water collects in a collecting container 11; see also FIG. 2, which collecting container 11 is configured as an annular space and is arranged downstream of the filter device 3. The cleaned water can be drawn off via an outflow 12.

Furthermore, the housing interior has provided therein a collecting container 13 which is arranged downstream of a central opening 14 of the filter device 3. In this collecting container 13 are collected pressed-out filter cakes which, on the one hand, are formed in the filter device 3 by the pressing elements 5 rolling over the filter device, but, on the other hand, are sucked out again from the apertures of the filter device 3 by way of said pressing elements, with the result that they can collect, while floating in the liquid, in the collecting container 13.

As FIG. 2 shows, the filter device 3 has a frustoconical shape or funnel shape. It is bolted on the housing via an annular flange 15 and is seated centrally on the collecting container 13. It can be seen that the pressing elements 5, of which three are provided here, which are arranged equidistantly around the circumference of the shaft 10, are also configured to be frustoconical, with the result that they lie on the filter device 3. Each pressing element 5 comprises a hollow element body 16 to the outer side of which there is applied an outer casing (not shown in further detail in FIGS. 1 and 2) which is composed of an elastic material and which will be described below.

In order to clamp the pressing elements 5 against the filter device 3, each pressing element 5 is preloaded against the filter device by a clamping device 17.

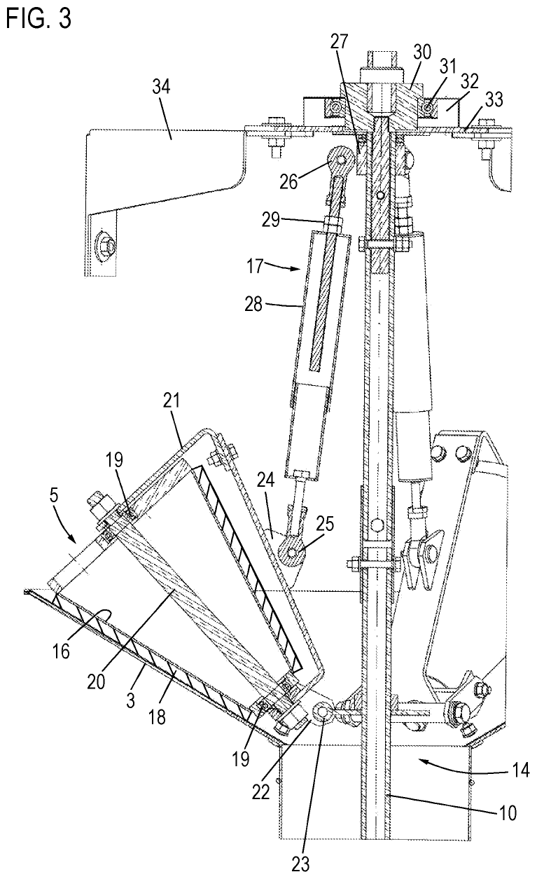

FIG. 3 is an enlarged detail view showing the region of the pressing elements 5 and of the filter device 3. There is shown, on the one hand, the filter device 3, which will be described in detail below, and also, in detail, a pressing element 5, with the element body 16, to which the already described elastic outer casing 18 is applied. This outer casing 18 is, for example, a mat composed of an elastic material such as an elastomer or the like, which mat is adhesively bonded to the element body 16 and is welded at the butting ends, resulting in an encircling, closed outer casing 18. The pressing element 5 is rotationally mounted via two bearing elements 19, here ball bearings, on a shaft 20 which is fastened to a holder 21. This, as it were clamp-like, holder 21 has its lower end coupled to a bearing element 23, which is connected to the shaft 10, so as to be pivotable via a bearing portion 22. Furthermore, the holder 21 is pivotably connected to the end 25 of a clamping device 17 via a further bearing element 24, with the clamping device 17 being coupled and pivotably connected by the other end 26 likewise to a corresponding holder 27 which in turn is connected to the shaft 10. This achieves a situation in which the corresponding pivoting connections allow a relative movement of the pressing element 5 such that it can be pressed firmly against the filter device 3 with deformation of the outer casing 18.

The or each clamping device 17 is an actuating cylinder 28, for example a hydraulic or pneumatic cylinder or a cylinder comprising a spring element or the like. In each case, this actuating cylinder 28, which can be varied in its length via an adjusting device 29 such that the contact pressure can be varied, makes it possible for each clamping device 5 to be correspondingly pressed against the filter device 3.

The holder 27 is, as described, likewise connected to the shaft 10. The shaft 10 is rotationally mounted in this region via a bearing block 30 and a bearing element 31 on a holder 32 which is fastened to a metal carrier sheet 33 which for its part is again fixed, on the housing inner side, via corresponding legs 34.

From there, the shaft 10; see FIG. 2, extends further and runs through the cover 7 of the housing 2, where it is connected to the drive motor 8 via a connecting element 35 so as to be constrained to rotate therewith, with the result that the shaft 10, and with it the pressing elements 5, can be rotated about the vertical axis 9.

At the other end, the shaft 10 runs through the opening 14 into the collecting container 13 and is received there in a corresponding bearing block 36 and rotationally mounted there and corresponding downwardly supported.

During operation, the drive motor 8 thus turns the shaft 10, with the result that the pressing elements 5 clamped against the filter device 3 by way of the clamping device 17 rotate about the vertical axis 9. At the same time, they roll on the filter device 3 by way of their elastic outer casing 18. That is to say that each pressing element rotates about two axes, namely, on the one hand, about the vertical axis 9 and, on the other hand, about the axis 20. Here, the elastic outer casing 18 rolls on the filter device 3 and, as described, presses a specific amount of liquid laden with dirt particles into the corresponding apertures of the filter device 3, where compression occurs on account of the elastic outer casing 18 being pressed in, with the result that, on the one hand, the water is pressed through the filter device 3 and is caught in the collecting container 11, whereas at the same time a filter cake is formed in each aperture and is subsequently sucked out again.

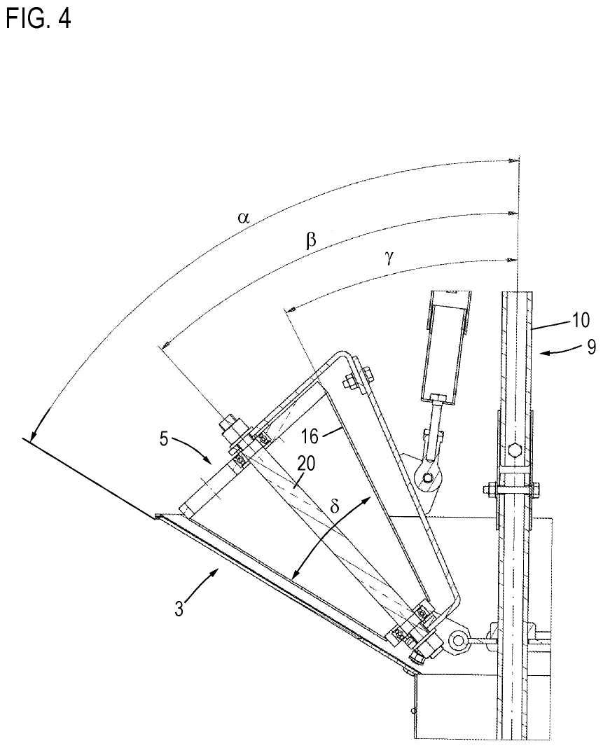

FIG. 4 is an enlarged partial view showing the angular geometry which the individual elements take with respect to one another. There is shown, on the one hand, the filter device 3 and, on the other hand, a pressing element 5, and also the vertical axis 9 in the form of the shaft 10. The filter device 3, which, as described, is configured to be funnel-shaped, has an angle α of 60° to the vertical axis 9, that is to say that the funnel-shaped filter device 3 has an opening angle of 120°.

The axis 20 about which each pressing element 5 rotates has an angle β of 45° to the vertical axis 9.

The pressing element 5 has the outer surface thereof of the element body 16, with said surface being situated closely to the vertical axis 9, at an angle γ of 30° to the vertical axis 9. Since the opposite side of the element body 16 runs parallel to the filter device 3, the side at that location is accordingly at an angle of likewise 60° to the vertical axis 9, just like the filter device 3. This results in an opening angle δ of the frustoconical element body 16 of 30°.

The fact that the filter device 3 and the adjacent side of the element body 16 are each at the same angle of 60° to the vertical axis 9 means that the elastic outer casing 18 situated therebetween is compressed virtually all over to the same degree over the entire bearing length.

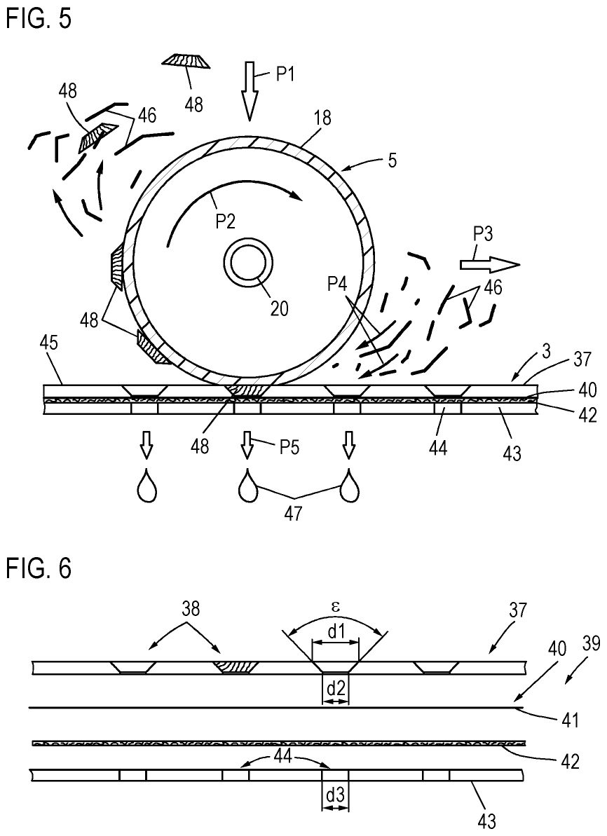

FIG. 5 shows, in the form of a basic illustration, the pressing-out operation. What is shown here by way of example is only the elastic outer casing 18 of a pressing element 5 along with the filter device 3. This filter device 3 consists of; see FIG. 6, a first filter plate 37 which has a multiplicity of apertures 38 which are round in cross section, that is to say are configured as conical bores. In the example shown, the opening angle c is 90°. The largest diameter d1 at the side of the filter plate 37 facing toward the elastic outer casing 18 is preferably 8 mm, resulting in a cross-sectional area of about 50.2 mm². At the opposite side, the minimum diameter d2 of the aperture 38 is preferably 5 mm, resulting in an opening cross section of about 19.6 mm².

Directly downstream of the filter plate 37, that is to say bearing against it, there is a filter means 39 comprising a hole filter 40 in the form of a perforated metal filter sheet 41 or of a, preferably tear-resistant, perforated plastics film or hole plastics membrane. The metal filter sheet 41 has a multiplicity of holes, which have a diameter of 1-50 μm, preferably of between 1-25 μm. In other words, this hole filter 40 allows passage therethrough of only particles which are small than the hole cross section, meaning therefore that only extremely small particles can still get through the filter device 3, with all other particles being retained by the hole filter 40.

The filter means 39 further comprises a filter nonwoven 42 which serves to distribute, in the filter nonwoven plane, the water pressed through the hole filter. However, apart from the distribution of the water, the filter nonwoven also serves to provide a certain manner of sealing toward the hole filter 40 so that a certain counterpressure can be built up from this side, with the result that there is formed, within the aperture 38, a sufficiently high pressing pressure which, on the one hand, presses the water through the hole filter 40 and through the filter nonwoven 42 and which, on the other hand, firmly compresses the particles 46 to form the filter cake 48.

Downstream of the filter nonwoven 42 there is, finally, a second filter plate 43 which likewise has a multiplicity of apertures 44, which are aligned with the apertures 38 of the first filter plate 37. The apertures 44 have a diameter d3 which preferably corresponds to the diameter d2, that is to say is preferably likewise 5 mm, therefore likewise providing an opening cross section of about 19.6 mm². The apertures 44 are no smaller in diameter than the minimum diameter of the apertures 38, but they can, where appropriate, also be somewhat larger. In each case, the water pressed through the hole filter 40, after it has also passed through the filter nonwoven 42 or has been distributed over the latter, can then flow off through the apertures 44 into the collecting space 11.

The function of the filter-pressing operation is illustrated in detail in FIG. 5. As described, the elastic outer casing 18, as illustrated by the arrow P1, presses under preloading onto the upper side 45 of the filter device 3. As is illustrated by the arrow P2, the pressing element 5 or the outer casing 18 rotates, on the one hand, about the shaft 20 and, on the other hand, about the vertical axis 9, with the result that it also moves around the latter, as illustrated by the arrow P3. It thus rolls on the upper side 45. Here, it is forced to roll over the apertures 38. While rolling over in such a way, what happens is that, on the one hand, as shown by the arrows P4, liquid including the particles 46 is pressed into a progressively rolled-over and thereby closed aperture 38. At the same time, however, the rolling-over action also causes a sufficiently high pressure to be exerted on the liquid situated in the aperture 38, not least since the elastic outer casing 18 presses slightly into the aperture 38. This results, on the one hand, in the liquid being pressed at high pressure against the hole filter 40 and being pressed through its holes into the filter nonwoven 42, whereafter the liquid flows off via the aperture 44. The liquid 47 is illustrated by way of the droplet symbols, with the arrows P5 showing the dripping action. At the same time, however, the particles 46 are retained by the hole filter 40 insofar as they are larger than the corresponding hole diameters. That is to say that a filter cake 48 consisting of firmly compressed particles 46 results in the conically tapering aperture 38.

Once the outer casing 18 then rolls further away, it rolls from the aperture 38, causing the latter to open continuously. What occurs here is that the individual filter cakes 48, which adhere somewhat to the outer casing 18, are concomitantly pulled out or sucked out of the aperture 38, since, upon opening of the outer casing 18 and rolling thereof, the outer casing material relaxes somewhat again. There thus occurs a certain suction effect, that is to say the formation of a negative pressure, with the result that the filter cakes 48 are sucked out. In other words, this results in self-cleaning of the filter device 3 since, on the one hand, the particles 46 are pressed into the apertures and strongly pressed to form the filter cakes 48, but, on the other hand, the individual apertures 38 are also automatically emptied again by virtue of the filter cakes 48 being pulled out or sucked out.

The rotating pressing elements 5 carry along the respectively adhering filter cakes 48, with the latter then being detached from the outer casing 18 and floating in the contaminated liquid situated in the upper container region. They sink downward in this region and pass either directly into the opening 14 or slide along the filter device 3 running conically toward the opening 14 into the opening 14 and, via the latter, into the collecting container 13. They can be drawn off therefrom as required, for which purpose either the collecting container 13 is opened, with this being associated with drainage of the dirty water also arising in the collecting container 13, or they can, preferably, also be extracted by suction via a corresponding suction-extraction nozzle 49, with the result that there is no need for the continuous filter process to be interrupted, not even for the removal of the filtered-off particles or filter cakes.

The elastic outer casing 18 is made of a sufficiently elastic material, preferably an elastomer or a rubber. It is preferably applied as a mat, but can also be applied as a coating. Its thickness is dimensioned in such a way that it can be sufficiently compressed, which, as explained with regard to FIG. 5, is required in order to generate the sufficient pressure in the respective filled aperture 38 such that the water 47 can be pressed out and at the same time the particles 46 can be compressed to form the filter cake 48, for which purpose the elastic outer casing 18 has to engage into the aperture 38 while molding itself into the shape thereof.

FIG. 1 also shows, finally, a filling level-monitoring device 50 which serves to be able to monitor the filling level of contaminated liquid in the upper region. Provided here is a transparent inspection glass 51, but it is also possible for an electronic filling level-monitoring device to be provided.

Although not illustrated in further detail, there further exists the possibility of also providing a filling level-monitoring device in the collecting container 11 in order to detect the filling level of cleaned water in this annular space. Additionally or alternatively, however, a filling level-monitoring device can also be present in the collecting container 13 in order to detect the filling level of introduced filter cakes 48 or else, where appropriate, loose particles 46 which may also form again as a result of the filter cakes 48 falling apart.

Depending on which filter device is provided, if it is electronic, a corresponding control of the associated peripheral devices can occur. In the case of an electronic liquid-monitoring device detecting the filling level of contaminated liquid, it is possible, for example, upon the filling level dropping to a minimum filling level, for a feed pump to be automatically activated such that the dirty water can be resupplied here via the inflow until a maximum filling level has been reached once again. In the case of an electronic filling level monitoring of the cleaned water, a pump, which draws off the liquid via the outflow 12, can be activated upon a maximum filling level being reached. Finally, in the case of an electronic filling level monitoring of the particle loading in the collecting container 13, a pump can be activated when a maximum filling level has been reached, with said pump allowing drawing-off of these particles 46 or filter cakes 48 together with a certain fraction of dirty water likewise situated in the collecting container 13.

While specific embodiments of the invention have been shown and described in detail to illustrate the inventive principles, it will be understood that the invention may be embodied otherwise without departing from such principles.

We claim:

1. A filter press, comprising a housing, which receives a liquid to be filtered that contains particles to be separated off, and a pressing device arranged in the housing for pressing the liquid through a filter device, wherein the pressing device, which rotates about a vertical axis, has at least one cross-sectionally round pressing element which rotates about an axis of rotation situated at an angle to the vertical axis and which has an outer casing formed from an elastic material, by means of which the pressing element rolls on the filter device, wherein the filter device comprises a filter means and, upstream of the filter means, a filter plate which has a plurality of apertures which are open toward the pressing element and each of which has a cross section reducing toward the filter means.

2. The filter press according to claim 1, wherein the apertures are round in cross section.

3. The filter press according to claim 2, wherein the apertures have an opening angle between 60°-120°, in particular between 75°-105° and preferably of 90°.

4. The filter press according to claim 2, wherein the apertures have a maximum diameter of 12 mm, in particular of 10 mm and preferably of 8 mm, and a minimum diameter of 8 mm, in particular of 6 mm and preferably of 5 mm.

5. The filter press according to claim 1, wherein the filter press has, downstream of the filter means, a second filter plate having second apertures aligned with the apertures of the first filter plate.

6. The filter press according to claim 5, wherein the cross section of the second apertures corresponds to the minimum cross section of the first apertures.

7. The filter press according to claim 1, wherein the filter means is or comprises a hole filter having a hole cross section of between 1-50 μm, in particular between 1-25 μm.

8. The filter press according to claim 7, wherein the hole filter is a perforated filter sheet or a perforated, preferably tear-resistant, plastics film.

9. The filter press according to claim 7, wherein a filter nonwoven is arranged directly downstream of the hole filter.

10. The filter press according to claim 1, wherein the outer casing is a covering composed of an elastomer, a thermoplastic elastomer or a rubber.

11. The filter press according to claim 1, wherein the outer casing is a mat which is fastened to a roller-shaped element body of the pressing element, or in that the outer casing is a coating.

12. The filter press according to claim 1, wherein a plurality of pressing elements are arranged so as to be offset in the circumferential direction and rotate jointly about the vertical axis.

13. The filter press according to claim 1, wherein the or each pressing element has a frustoconical shape.

14. The filter press according to claim 13, wherein the or each pressing element has an opening angle of 30°.

15. The filter press according to claim 1, wherein the filter device is frustoconical.

16. The filter press according to claim 15, wherein the filter device has an opening angle of 120°.

17. The filter press according to claim 1, wherein a collecting container for the pressed-through liquid is arranged downstream of the filter device.

18. The filter press according to claim 1, wherein the filter device has a central opening through which the vertical axis runs.

19. The filter press according to claim 17, wherein a collecting container for filter cakes consisting of compressed particles is arranged downstream of the opening of the filter device.

20. The filter press according to claim 1, wherein the or each press element is clamped against the filter device by way of a clamping device.

21. The filter press according to claim 19, wherein the or each clamping device is an actuating cylinder, in particular a hydraulic or pneumatic cylinder or a cylinder comprising a spring element.

22. The filter press according to claim 20, wherein the or each actuating cylinder is fastened by one end to a holder on which the pressing element is rotatably mounted and by the other end to a holder coupled to the vertical axis.

23. The filter press according to claim 1, wherein the vertical axis is formed by means of a shaft which is mounted so as to be rotatable by way of bearing elements and which is coupled to a drive motor and to which the pressing element(s) is/are coupled.

24. The filter press according to claim 22, wherein the shaft has its upper end running out of the housing and is coupled outside the housing to the drive motor, and/or in that the shaft has its lower end running into the collecting container and is rotationally mounted there.

25. The filter press according to claim 1, wherein a filling level-monitoring device, in particular a riser, is provided on or in a housing region above the filter device.

26. The filter press according to claim 17, wherein a liquid level-monitoring device, in particular a riser, is provided on or in the collecting container which receives the purified liquid.

27. The filter press according to claim 19, wherein a filling level-monitoring device is provided on or in the collecting container which receives the filter cakes.
